(19) United States
(12) Patent Application Publication
(10) Pub. No.: US 2024/0352567 A1
(43) Pub. Date: Oct. 24, 2024

(54) METHOD FOR MANUFACTURING FE-SI-B-BASED THICK PLATE RAPIDLY SOLIDIFIED ALLOY RIBBON

(71) Applicant: HILLTOP CORPORATION, Uji-shi, Kyoto (JP)

(72) Inventor: Hirokazu KANEKIYO, Kyoto-shi, Kyoto (JP)

(21) Appl. No.: 18/683,679

(22) PCT Filed: Aug. 4, 2022
(86) PCT No.: PCT/JP2022/029912

§ 371 Date: Feb. 14, 2024

(30) Foreign Application Priority Data
Aug. 17, 2021 (JP) 2021-132617

(51) Int. Cl. C22C 45/02; C22C 38/00; C22C 38/02; C22C 38/12; C22C 38/16

(52) U.S. Cl. CPC C22C 45/02; C22C 38/002; C22C 38/02; C22C 38/12; C22C 38/16; C22C 2200/02; C22C 2202/02

(57) ABSTRACT

Provided is a method that includes ejecting an Fe—Si—B-based molten alloy containing iron (Fe), boron (B), and silicon (Si) as essential components from a tapping nozzle to a surface of a cooling roll and rotating the cooling roll at a surface speed of 15 m/sec or more and 50 m/sec or less to rapidly cool the Fe—Si—B-based molten alloy on the surface of the cooling roll to manufacture an alloy ribbon, the tapping nozzle includes a single slit formed to have a width of 0.6 mm or more and less than 2.0 mm, the cooling roll has a curvature of 8×10⁻⁴ or more and less than 2×10⁻³, and the method includes passing cooling water in an amount of 0.3 m³/min or more and less than 20 m³/min at 5° C. or more and less than 60° C. through the cooling roll to manufacture a rapidly solidified alloy ribbon having an average thickness of 30 μm or more and less than 55 μm.

### TECHNICAL FIELD

The present invention relates to a method for manufacturing an Fe—Si—B-based thick plate rapidly solidified alloy ribbon.

### BACKGROUND ART

The market has recently demanded materials having a low iron loss and a high saturation magnetic flux density for various passive elements such as inductors and reactors used as electronic components and transformers. As materials having a high magnetic permeability and a lower iron loss than electrical steel sheets, soft magnetic materials are known. Soft magnetic materials, such as iron-based amorphous materials and iron-based nanocrystal materials, mainly contain iron (Fe), boron (B), and silicon (Si). Fe—Si—B-based rapidly solidified alloy ribbons having a thickness of about 17 μm to 25 μm, which are produced by molten metal rapid solidification processing using such a soft magnetic material, are used as a wound iron core in inductors, transformers, and the like, and Fe—Si—B-based rapidly solidified alloy ribbons have been increasingly demanded year by year as substitutes for conventional electrical steel sheets.

Iron-based amorphous alloys have excellent soft magnetic characteristics such as an iron loss of about 1/10 and a magnetic permeability of three times or more of those of electrical steel sheets (silicon steel sheets) used as a laminated iron core for motors. Therefore, iron-based amorphous alloys are expected to be used as a wound iron core for inductors and transformers as described above, and in addition, for motors to contribute to downsizing and improvement in efficiency of the motors. However, iron-based amorphous alloys having a thickness of about 17 μm to 25 μm are applied as a wound iron core only to some limited motors because, for example, such iron-based amorphous alloys cannot be subjected to punching required for forming a laminated iron core, and in addition, the space factor decreases.

In an Fe—Si—B-based amorphous alloy, an amorphous structure cannot be conventionally obtained unless the alloy is a rapidly solidified alloy ribbon having a thickness of about 17 μm to 25 μm rapidly solidified at a very high rapid solidification rate of 10⁴ to 10⁶ K/sec. However, Non Patent Literature 1 discloses that the rapid solidification rate is reduced by adding phosphorus (P) and thus an iron-based amorphous alloy ribbon having a thickness of about 50 μm is obtained. However, the phosphorus-added alloy not only causes a decrease in the saturation magnetic flux density Bs due to the addition of phosphorus, but also causes significant contamination inside and outside the molten metal rapidly cooling apparatus due to volatilization of the phosphorus component at the time of melting the alloy, and furthermore, the phosphorus-added alloy may easily burn, so that there are still few application examples in the industrial field.

Patent Literature 1 and Patent Literature 2 disclose a method for manufacturing a rapidly cooled alloy ribbon having a plate thickness (50 μm or more) such that punching can be performed with a multi-slit method in which a molten alloy is discharged from a plurality of slit nozzles onto a rotating cooling roll. However, Patent Literature 1 and Patent Literature 2 do not disclose specifications and operational parameters of a manufacturing apparatus for mass-producing an iron-based amorphous alloy having such a plate thickness at low cost while stably maintaining the homogeneity and the uniform quality of the amorphous alloy.

Patent Literature 3 and Patent Literature 4 disclose a method for producing an iron-based amorphous alloy having a plate thickness of 30 μm or more by alternately discharging a molten metal from a multi-slit nozzle to two cooling rolls. The manufacturing apparatus used in this method requires two cooling rolls, and therefore the manufacturing cost and the running cost are greatly increased, and in addition, the gap control between the nozzle tip and the cooling roll surface, which greatly affects the plate thickness and the rapid cooling state of the iron-based amorphous alloy, is extremely difficult as compared with a normal single roll molten metal rapidly cooling apparatus having only one cooling roll.

Patent Literature 5 discloses a cooling roll used in a single roll molten metal rapidly cooling apparatus for manufacturing an iron-based amorphous alloy having a plate thickness of 30 μm or more, but there is a problem that the manufacturing cost is high because of the complicated structure of the cooling water flow channel. Patent Literature 5 describes that the flow rate of the cooling water is increased as the plate thickness of the amorphous foil strip increases, but does not clarify the optimum amount of the roll cooling water. Furthermore, a roll diameter depending on the plate thickness of an amorphous ribbon is recommended. However, preparing a plurality of cooling rolls and drive mechanisms according to the plate thickness greatly increases the manufacturing cost of the apparatus, and thus the apparatus is difficult to apply as a mass production apparatus in consideration of the production efficiency.

Patent Literature 6 discloses a method for manufacturing a metal ribbon in which the thickness of a metal ribbon is restrained from being non-uniform at the time of producing a rapidly cooled wide ribbon using a multi-hole nozzle. The invention of Patent Literature 6 is characterized by the shape of the nozzle opening, but there is a problem that the nozzle processing cost increases because of the difficult processing, and thus this invention is difficult to use at a mass production level.

Patent Literature 7 discloses a method for producing a brazing ribbon having a thickness of 50 to 200 μm with a single roll molten metal rapidly cooling apparatus, but the brazing ribbon obtained by this method is a crystalline Ni-based alloy, and thus Patent Literature 7 does not disclose a technique for manufacturing a rapidly solidified alloy having an amorphous structure with a thickness of about 50 μm.

Patent Literature 8 discloses a method for manufacturing an Fe-based amorphous alloy ribbon in which wave-like undulations are formed on a free surface with a single roll method for the purpose of reducing hysteresis loss that is a main factor of iron loss of a wide amorphous alloy ribbon. Patent Literature 8 describes the temperature distribution in the width direction of the molten metal nozzle and the roughness of the cooling roll surface, but does not disclose a technique for manufacturing an iron-based rapidly solidified alloy having an amorphous structure applicable to a laminated iron core.

As a technique for manufacturing an Fe—Si—B-based molten metal rapidly cooled alloy having a thickness of 30 μm or more using a conventional slit nozzle as described above, a technique has been proposed in which a multi-slit tapping nozzle is used that includes a plurality of rows of slits disposed perpendicularly to the rotation direction of the cooling roll, in addition to adding phosphorus (P) or the like to improve the amorphous-forming ability of the alloy. However, if the tapping rate is increased by, for example, ejecting the molten metal from the plurality of rows of slits, the molten alloy becomes difficult to rapidly cool with the cooling roll, and an amorphous structure is less likely to be obtained. Therefore, as a solution to this problem, measures have been conventionally considered in which, for example, the cooling water channel structure in a cooling roll is devised, or two cooling rolls are disposed in parallel to supply molten metal alternately. In any of these measures, the configuration of the molten metal rapidly cooling apparatus becomes complicated, so that a molten metal rapidly cooling technique for stably mass-producing an Fe—Si—B based molten metal rapidly cooled alloy having a thickness of 30 μm or more at low cost has not been established, and there has been no record of provision to the market at a mass production level so far.

### CITATION LIST

### Patent Literatures

Patent Literature 1: JP H5-329587 A

Patent Literature 2: JP H7-113151 A

Patent Literature 3: Japanese Patent No. 5114241

Patent Literature 4: Japanese Patent No. 5270295

Patent Literature 5: JP 2015-205290 A

Patent Literature 6: JP S63-220950 A

Patent Literature 7: JP S63-157793 A

Patent Literature 8: Japanese Patent No. 6107140

### Non Patent Literature

Non Patent Literature 1: Creation of new bulk metallic glass/amorphous thick plate with high saturation magnetic flux density (Tohoku University, Institute for Materials Research) Akihiro Makino, Ken Kubota, Tsuneharu Tsune

### SUMMARY OF INVENTION

### Technical Problem

At present, Fe—Si—B-based amorphous materials applied to transformers and the like have a thickness of around 20 μm, which is not at a thickness level available for laminated iron cores. The prior technique enabling an Fe—Si—B-based amorphous material to be thickened causes deterioration of soft magnetic characteristics, or has problems in productivity and cost. Therefore, the electronic component market has strongly desired a method for mass-producing an alloy ribbon including an inexpensive and high-performance Fe—Si—B-based amorphous material that can be thickened regardless of the alloy composition.

Therefore, an object of the present invention is to provide a method for manufacturing an Fe—Si—B-based thick plate rapidly solidified alloy ribbon in which an Fe—Si—B-based thick plate rapidly solidified alloy ribbon suitable as a laminated iron core of a motor or the like can be easily mass-produced at low cost.

### Solution to Problem

FIG. 5 is a schematic configuration view of an apparatus used in a conventional method for manufacturing an Fe—Si—B-based rapidly solidified alloy ribbon. As illustrated in FIG. 5, a molten alloy supplied from a nozzle 52 of a molten metal container 51 to the surface of a cooling roll 54 is rapidly cooled on the cooling roll 54 and then peeled off from the cooling roll 54 to obtain an Fe—Si—B-based molten metal rapidly cooled alloy ribbon. On the surface of the cooling roll 54, primary cooling is performed in which an amorphous structure is obtained by rapidly cooling the molten alloy so as to pass between the melting point and the glass transition temperature of the alloy quickly without crystallization. The rapidly solidified alloy subjected to the primary cooling is in a supercooled state, and therefore may be recrystallized by self-heating due to latent heat of solidification.

Therefore, in a conventional mass production process of an Fe—Si—B-based rapidly solidified alloy, primary cooling is performed in a state where the molten metal ejected onto the surface of the cooling roll 54 adheres to the surface of about a half round of the cooling roll 54, and the latent heat of solidification is removed. A rapidly solidified alloy ribbon 55 including the amorphous structure formed by the primary cooling is subjected to secondary cooling in a solid phase state and peeled off from the cooling roll 54.

In the conventional technique, if the rapidly solidified alloy ribbon 55 is peeled off from the cooling roll 54 immediately after the rapid solidification, the latent heat of solidification of the rapidly solidified alloy ribbon 55 in a supercooled state is released to cause recrystallization, and therefore the molten metal is brought into contact with about a half round of the cooling roll 54 in order to prevent recrystallization. However, if the distance from the molten metal supply position to the peeling position on the surface of the cooling roll 54 is increased in this manner, the time until the molten metal is supplied again to the peeling position by rotation of the cooling roll 54 is shortened, and as a result, if the molten metal supply rate per unit time is increased, the molten metal supply to the cooling roll 54 is repeated in a state where the surface temperature of the cooling roll 54 is not sufficiently lowered. As a result, the surface temperature of the cooling roll 54 excessively increases, and there is a possibility that the molten metal rapid cooling cannot be continued.

Through various tests, the present invention has clarified the heat removing ability required for a cooling roll in order to form a rapidly solidified alloy structure in which recrystallization due to release of latent heat of solidification does not occur. That is, the present invention has clarified preferable conditions of the surface speed, the curvature, the cooling water amount, and the cooling water temperature of a cooling roll according to the size of a rapidly solidified alloy ribbon, and thus makes it possible to easily mass-produce an Fe—Si—B-based molten metal rapidly cooled alloy ribbon that can be suitably used for a laminated iron core of a motor or the like at low cost without complicating the configuration of a manufacturing apparatus.

The above-described object of the present invention is achieved by a method for manufacturing an Fe—Si—B-based thick plate rapidly solidified alloy ribbon, and the method includes ejecting an Fe—Si—B-based molten alloy containing iron (Fe), boron (B), and silicon (Si) as essential components from a tapping nozzle to a surface of a cooling roll and rotating the cooling roll at a surface speed of 15 m/sec or more and 50 m/sec or less to rapidly cool the Fe—Si—B-based molten alloy on the surface of the cooling roll to manufacture an alloy ribbon, the tapping nozzle includes a single slit formed to have a width of 0.6 mm or more and less than 2.0 mm, the cooling roll has a curvature of 8×10⁻⁴ or more and less than 2×10⁻³, and the method includes passing cooling water in an amount of 0.3 m³/min or more and less than 20 m³/min at 5° C. or more and less than 60° C. through the cooling roll to manufacture a rapidly solidified alloy ribbon having an average thickness of 30 μm or more and less than 55 μm.

In the method for manufacturing an Fe—Si—B-based thick plate rapidly solidified alloy ribbon, the single slit of the tapping nozzle preferably has a length of 20 mm or more and less than 300 mm.

It is preferable that the cooling roll include a material containing one of Cu, Mo, or W as a main component, have an arithmetic average roughness Ra of the surface of 10 nm or more and less than 20 μm, be formed to have a length longer than the length of the single slit by 50 mm or more and less than 400 mm, and have a thickness from the surface to a flow channel of the cooling water of 5 mm or more and less than 50 mm.

The Fe—Si—B-based molten alloy is preferably ejected from the single slit at a tapping pressure of 5 kPa or more and less than 40 kPa.

The cooling roll preferably has a diameter of 1000 mm or more and less than 2500 mm.

The Fe—Si—B-based molten alloy preferably has a composition formula represented by T_{100-x-y-z-n}QₓSi_{y}Mₙ wherein T represents a transition metal element including at least one element selected from the group consisting of Fe, Co, and Ni, the transition metal element necessarily including Fe, Q represents one or more elements selected from the group consisting of B and C, the one or more elements necessarily including B, M represents one or more elements selected from the group consisting of P, Al, Ti, V, Cr, Mn, Nb, Cu, Zn, Ga, Mo, Ag, Hf, Zr, Ta, W, Pt, Au, and Pb, and composition ratios x, y, and n satisfy 5≤x<20 atom %, 2≤y<15 atom %, and 0≤n<10 atom %.

The above-described method for manufacturing an Fe—Si—B-based thick plate rapidly solidified alloy ribbon makes it possible to obtain an Fe—Si—B-based thick plate rapidly solidified alloy ribbon having an average thickness of 30 μm or more and less than 55 μm usable as a laminated iron core, which is easily applied to a motor or the like, and thus, for example, an Fe—Si—B-based thick plate rapidly solidified alloy ribbon including 90 vol % or more of an amorphous structure can be easily manufactured at low cost. A rapidly solidified alloy ribbon having such a size is suitable for, for example, manufacturing a laminated iron core applied to a motor for EV, a compressor, a generator, or the like. After processing the Fe—Si—B-based thick plate rapidly solidified alloy ribbon into a desired shape by punching, wire cutting, laser cutting, or the like, a laminated iron core can be obtained using a method such as resin adhesion or caulking. The produced laminated iron core can be further processed by wire cutting, laser cutting, or the like to obtain a divided iron core usable for a motor.

### Advantageous Effects of Invention

According to the method for manufacturing an Fe—Si—B-based thick plate rapidly solidified alloy ribbon of the present invention, an Fe—Si—B-based thick plate rapidly solidified alloy ribbon suitable as a laminated iron core of a motor or the like can be easily mass-produced at low cost.

### BRIEF DESCRIPTION OF DRAWINGS

FIG. 1 is a schematic configuration view of an apparatus used in a method for manufacturing an Fe—Si—B-based thick plate rapidly solidified alloy ribbon according to an embodiment of the present invention.

FIGS. 2(a) and 2(b) are enlarged views illustrating a main part of the apparatus illustrated in FIG. 1, and FIG. 2(a) is a sectional view and FIG. 2(b) is a bottom view.

FIG. 3 is a schematic view for describing details of a method for manufacturing an Fe—Si—B-based thick plate rapidly solidified alloy ribbon according to an embodiment of the present invention.

FIGS. 4(a) and 4(b) are enlarged views illustrating another main part of the apparatus illustrated in FIG. 1, and FIG. 4(a) is a longitudinal sectional view and FIG. 4(b) is a sectional view taken along line A-A in FIG. 4(a).

FIG. 5 is a schematic configuration view of an apparatus used in a conventional method for manufacturing an Fe—Si—B-based rapidly solidified alloy ribbon.

FIG. 6 shows X-ray diffraction patterns of an Fe—Si—B-based rapidly solidified alloy ribbon obtained in an example of the present invention.

FIG. 7 shows X-ray diffraction patterns of an Fe—Si—B-based rapidly solidified alloy ribbon obtained in another example of the present invention.

FIG. 8 shows X-ray diffraction patterns of an Fe—Si—B-based rapidly solidified alloy ribbon obtained in a comparative example of the present invention.

### DESCRIPTION OF EMBODIMENTS

### [Alloy Composition]

A molten alloy used in a method for manufacturing an Fe—Si—B-based thick plate rapidly solidified alloy ribbon of the present embodiment has a composition formula represented by T_{100-x-y-z-n}QₓSi_{y}Mₙ. Q represents one or more elements selected from the group consisting of B and C, and the one or more elements necessarily include B. M represents one or more elements selected from the group consisting of P, Al, Ti, V, Cr, Mn, Nb, Cu, Zn, Ga, Mo, Ag, Hf, Zr, Ta, W, Pt, Au, and Pb. Composition ratios x, y, and n satisfy 5≤x<20 atom %, 2≤y<15 atom %, and 0≤n<10 atom %.

The transition metal T including Fe as an essential element occupies the balance other than Q, Si, and M. Desired hard magnetic characteristics can be obtained even if a part of Fe is substituted with Co or Ni or with Co and Ni, which are ferromagnetic elements like Fe. However, substitution of more than 30% of Fe causes a significant decrease in the magnetic flux density, and therefore the amount of substituted Fe is limited to the range of 0% to 30%.

If the composition ratio x of Q(=B+C) is less than 5 atom %, the amorphous-forming ability greatly deteriorates, and α-Fe is precipitated at the time of rapid solidification of the molten metal. Meanwhile, in the case of a soft magnetic composition, if the composition ratio x is more than 20 atom %, the component ratio of Fe is decreased, so that the magnetic flux density is decreased to make it difficult to obtain a high-performance soft magnetic material. Therefore, the composition ratio x is 5 atom % or more and less than 20 atom %. The composition ratio x is preferably 7 atom % or more and less than 19 atom %, and more preferably 8 atom % or more and less than 19 atom %.

If the substitution rate C/(B+C) of C for B in Q increases, the melting point of the molten alloy decreases, and the wear amount of the refractory used at the time of rapid solidification decreases, so that the process cost of rapid solidification can be suppressed. However, if the substitution rate of C for B is too large, the amorphous-forming ability greatly deteriorates, and therefore the substitution rate C/(B+C) is preferably 0 or more and less than 0.5, more preferably 0 or more and less than 0.3, and still more preferably 0 or more and less than 0.2.

Si is effective as an element that improves the amorphous-forming ability and increases the magnetic permeability of an iron-based boron-based rapidly solidified alloy when added simultaneously with Fe and B, but if the amount y of Si added is more than 15 atom %, the saturation magnetic flux density Bs is greatly decreased, and therefore y is less than 15 atom %. Furthermore, y is preferably 2 atom % or more from the viewpoint of improving the magnetic permeability. y is more preferably 2.5 atom % or more and less than 12 atom %.

Addition of M improves the productivity at the time of rapid solidification as a result of improvement in the amorphous-forming ability, refinement of the rapidly solidified metal structure, and the like. However, if the composition ratio n of M is more than 10 atom %, the saturation magnetic flux density Bs is decreased, and therefore n is limited to 0 atom % or more and less than 10 atom %. n is preferably 0 atom % or more and less than 7 atom %, and more preferably 0 atom % or more and less than 5 atom %.

### [Rapidly Solidifying Apparatus for Molten Alloy (Single Roll Molten Metal Rapidly Cooling Apparatus)]

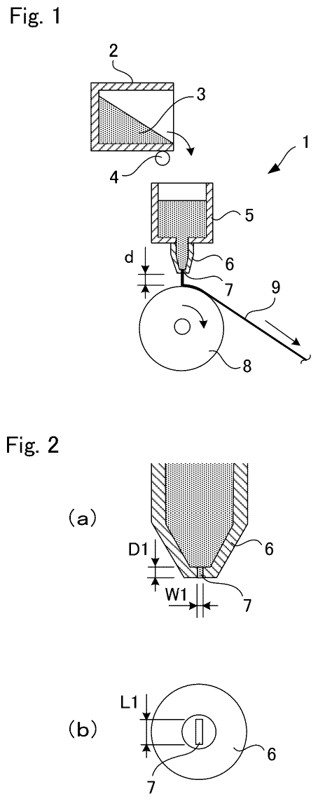

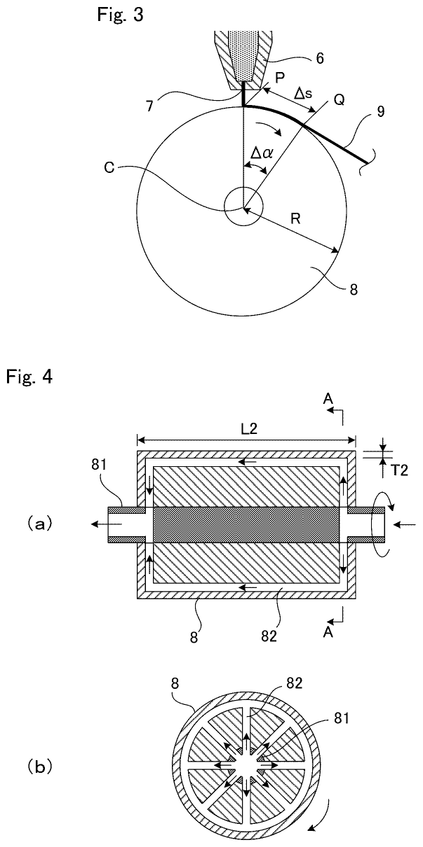

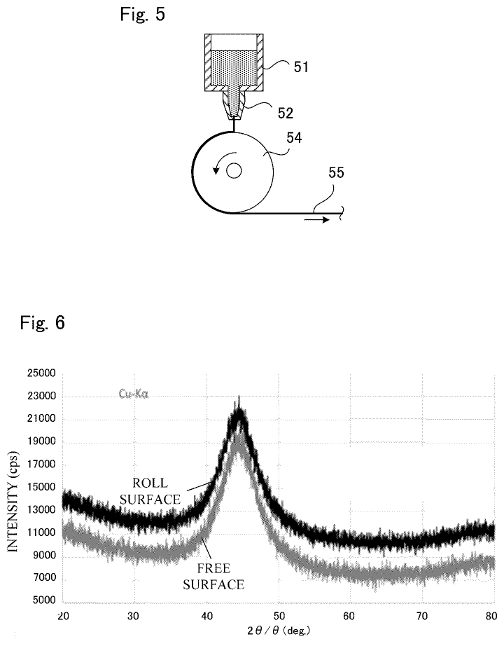

FIG. 1 is a schematic configuration view of a single roll molten metal rapidly cooling apparatus used in a method for manufacturing an Fe—Si—B-based thick plate rapidly solidified alloy ribbon according to an embodiment of the present invention. A single roll molten metal rapidly cooling apparatus 1 illustrated in FIG. 1 includes a melting furnace 2, a molten metal storage container 5, and a cooling roll 8.

The melting furnace 2 supplies a molten alloy 3 obtained by melting a raw material to the molten metal storage container 5 by rotation of a tilting shaft 4. The molten metal storage container 5 includes a tapping nozzle 6 at the bottom, and ejects the molten alloy 3 from a slit 7 formed at the lower end of the tapping nozzle 6 to the surface (outer peripheral surface) of the cooling roll 8. Cooling water is supplied to the inside of the cooling roll 8, and thus the molten alloy in contact with the surface of the cooling roll 8 is rapidly cooled to form a rapidly solidified alloy ribbon 9.

FIGS. 2(a) and 2(b) are enlarged views illustrating the tapping nozzle 6 of the apparatus illustrated in FIG. 1, and FIG. 2(a) is a sectional view and FIG. 2(b) is a bottom view. The tapping nozzle 6 illustrated in FIG. 2(a) is a single slit nozzle in which the single slit 7 is formed. The width W1 of the slit 7 is set to 0.6 mm or more and less than 2.0 mm. If the width is less than 0.6 mm, the flow of the molten metal passing through the slit 7 is inhibited to decrease the tapping rate, and thus the rapidly solidified alloy ribbon 9 having an average thickness of 30 μm or more is difficult to obtain. Meanwhile, if the width is 2.0 mm or more, the tapping rate of the molten metal supplied to the cooling roll 8 is too high and the molten metal cannot be sufficiently cooled by the cooling roll 8, so that a desired amorphous structure may be not obtained. In consideration of the processability and the accuracy of the slit, the width W1 of the slit 7 is more preferably 0.7 mm or more and less than 1.6 mm, and still more preferably 0.7 mm or more and less than 1.4 mm.

The length L1 of the slit 7 illustrated in FIG. 2(b) is appropriately selected according to the width of the cooling roll and the required size of an iron core for a motor or the like, and is not necessarily limited. However, if the length is less than 20 mm, the application field as a laminated iron core is limited. Meanwhile, if the length is 300 mm or more, the tapping rate of the molten metal supplied to the cooling roll 8 is too large and the molten metal cannot be sufficiently cooled by the cooling roll 8, so that a desired amorphous structure may be not obtained. Therefore, the length L1 of the slit 7 is preferably 20 mm or more and less than 300 mm, and in consideration of the productivity including the running cost and the cost of the single roll molten metal rapidly cooling apparatus, the length L1 is more preferably 30 mm or more and less than 250 mm, and still more preferably 40 mm or more and less than 200 mm.

The depth D1 of the slit 7 illustrated in FIG. 2(a) is determined based on the thickness of the bottom of the tapping nozzle 6. However, if the depth D1 is less than 2 mm, the strength of the bottom tends to be insufficient. Meanwhile, if the depth D1 is 15 mm or more, the temperature of the molten metal passing through the slit 7 is decreased to increase the possibility of nozzle clogging. Therefore, the depth D1 of the slit 7 is preferably 2 mm or more and less than 15 mm, and in consideration of tapping stability (straightness), the depth D1 is more preferably 3 mm or more and less than 12 mm, and still more preferably 3 mm or more and less than 10 mm.

In FIG. 1, the molten metal supplied from the tapping nozzle 6 to the cooling roll 8 forms a molten metal pool (paddle) on the surface of the cooling roll 8 and thus a molten metal rapid cooling solidification reaction occurs, so that generation of an appropriate paddle is important. If the distance d from the tip of the tapping nozzle 6 to the surface of the cooling roll 8 is 30 mm or more, generation of a paddle is unstable, and if the distance d is less than 0.15 mm, it is difficult to keep the distance d constant due to thermal expansion of the cooling roll 8. Therefore, the distance d is preferably 0.15 mm or more and less than 30 mm. In consideration of equipment cost for precisely controlling the distance d, the distance d is more preferably 0.3 mm or more and less than 30 mm, and in consideration of the homogeneity of the rapidly solidified alloy structure, the distance d is still more preferably 0.3 mm or more and less than 20 mm.

As illustrated in FIG. 4, while the molten metal supplied to the surface of the cooling roll 8 moves by rotation of the cooling roll 8 from the pouring position P immediately below the slit 7 of the tapping nozzle 6 to the peeling position Q at which the molten metal becomes the rapidly solidified alloy ribbon 9 and is peeled off from the cooling roll 8, primary cooling in which the molten alloy is rapidly cooled to a supercooled liquid state and secondary cooling in which latent heat of solidification is removed from the supercooled liquid to prevent recrystallization are performed. The distance Δs from the pouring position P to the peeling position Q needs to secure a distance required for completing the primary cooling and the secondary cooling. However, the surface temperature of the cooling roll 54 needs to be sufficiently lowered while the peeling position Q rotates to the pouring position P again. Therefore, the rotation angle Δα of the cooling roll 8 from the pouring position P to the peeling position Q is preferably small enough to allow the line between the pouring position P and the peeling position Q to be regarded as a straight line. In this case, the radius R of the cooling roll 8 is determined with the following formula.

$$R = {lim}_{Δ s \to 0} \vert Δ s / Δα \vert = \vert ds / d α \vert$$

In a case where the cooling roll 8 is rotated so that the surface speed is 15 m/sec or more and 50 m/sec or less, As can be determined from the time required for the primary cooling and the secondary cooling, and thus a preferable numerical range of the diameter 2R of the cooling roll 8 is determined. The preferable value of As depends on the size of the rapidly solidified alloy ribbon 9, and in the case of obtaining the rapidly solidified alloy ribbon 9 having an average thickness of 30 μm or more and less than 55 μm, the diameter 2R of the cooling roll 8 is 1000 mm or more and less than 2500 mm, and in consideration of the homogeneity of the rapidly solidified alloy structure, the diameter 2R is preferably 1500 mm or more and less than 2500 mm, and in consideration of restriction on the processing apparatus of the cooling roll, which is manufactured with a forging method or the like, and the manufacturing cost, the diameter 2R is more preferably 1500 mm or more and less than 2300 mm.

The curvature K of the cooling roll 8 is the reciprocal of the radius R, and therefore in the case of obtaining the rapidly solidified alloy ribbon 9 having an average thickness of 30 μm or more and less than 55 μm, the curvature κ is 8×10⁻⁴ or more and less than 2×10⁻³, preferably 8×10⁻⁴ or more and less than 1.3×10⁻³, and more preferably 8.7×10⁻⁴ or more and less than 1.3×10⁻³.

For completing the primary cooling and the secondary cooling within the distance Δs, the amount and the temperature of cooling water of the cooling roll 8 are also important factors. FIGS. 4(a) and 4(b) are schematic configuration views illustrating an example of the cooling roll 8, and FIG. 4(a) is a longitudinal sectional view and FIG. 4(b) is a sectional view taken along line A-A. The cooling water supplied from one end side (IN side) to a rotating shaft 81 of the cooling roll 8 radially spreads along a flow channel 82, cools the entire surface of the cooling roll 8, and then is merged and discharged from the other end side (OUT side) of the rotating shaft 81. In the case of obtaining the rapidly solidified alloy ribbon 9 having an average thickness of 30 μm or more and less than 55 μm, if the amount of cooling water is less than 0.3 m³/min, completion of the primary cooling and the secondary cooling on the surface of the cooling roll 8 is difficult. Meanwhile, if the amount of cooling water is 20 m³/min or more, the surface temperature of the cooling roll 8 during molten metal cooling does not increase and thus the temperature difference ΔT between the IN side temperature and the OUT side temperature of the cooling roll 8 is small (for example, 1° C. or less), so that the paddle generated on the surface of the cooling roll 8 becomes unstable. Therefore, the amount of cooling water is 0.3 m³/min or more and less than 20 m³/min, and in the single roll molten metal rapidly cooling apparatus 1 capable of mass production assuming continuous operation, the amount of cooling water is preferably 0.5 m³/min or more and less than 20 m³/min, and more preferably 0.5 m³/min or more and less than 15 m³/min.

The temperature of cooling water of the cooling roll 8 affects the adhesion between the molten alloy and the cooling roll 8. If the temperature of cooling water is less than 5° C., the adhesion between the molten alloy and the cooling roll 8 is impaired, and the ability of the cooling roll 8 to remove the heat of the molten alloy deteriorates. Meanwhile, if the temperature of the cooling water is 60° C. or more, a failure may be induced in a pump that supplies cooling water to the cooling roll 8. Therefore, the temperature of cooling water is 5° C. or more and less than 60° C. For further improving the adhesion between the molten alloy and the cooling roll 8, the lower limit of the cooling water temperature is particularly important, and is preferably 15° C. or more and less than 60° C., and more preferably 30° C. or more and less than 60° C.

The adhesion between the molten alloy and the cooling roll 8 is also affected by the material of the cooling roll 8. In consideration of thermal conduction and the melting point of the material, the cooling roll 8 preferably includes a material containing one of Cu, Mo, or W as a main component, and in consideration of equipment cost and running cost, a material containing Cu as a main component is preferable. Examples of the material containing Cu as a main component include alloys containing Cu at a content ratio of more than 50 mass %, and in addition, pure copper (the same applies to the material containing Mo or W as a main component).

The surface roughness of the surface of the cooling roll 8 also affects the adhesion between the molten alloy and the cooling roll 8, and therefore the arithmetic average roughness Ra of the surface of the cooling roll is preferably 10 nm or more and less than 20 μm, and in consideration of production efficiency and quality, Ra is more preferably 50 nm or more and less than 10 μm, and still more preferably 100 nm or more and less than 10 μm.

The length L2 of the cooling roll 8 in the axial direction illustrated in FIG. 4(a) is preferably longer than the length of the slit 7 illustrated in FIG. 2(b) by 50 mm or more and less than 400 mm, and in consideration of the cooling ability and the procurement cost of the cooling roll, the length L2 is more preferably longer than the length of the slit 7 by 100 mm or more and less than 300 mm, and still more preferably by 100 mm or more and less than 200 mm.

The ability of the cooling roll 8 to remove the heat of the molten alloy is also affected by the thickness T2 from the surface of the cooling roll 8 to the flow channel 82 illustrated in FIG. 4(a). If the thickness T2 is less than 5 mm, the mechanical strength of the cooling roll 8 is difficult to maintain. Meanwhile, if the thickness T2 is 50 mm or more, the surface temperature of the cooling roll 8 in contact with the molten alloy is locally equal to or higher than the melting point, so that the rapidly solidified alloy may be welded to the surface of the cooling roll 8 and thus the molten metal rapid cooling may be not continued. Therefore, the thickness T2 of the cooling roll 8 is preferably 5 mm or more and less than 50 mm. In consideration of wear caused by roll polishing operation after the molten metal rapid cooling, the thickness T2 is more preferably 10 mm or more and less than 50 mm, and in consideration of the operational stability of the molten metal rapid cooling process, the thickness T2 is still more preferably 10 mm or more and less than 40 mm.

The molten alloy ejected from the slit 7 of the tapping nozzle 6 is pressed against the surface of the cooling roll 8 to generate a paddle as described above. However, if the pressure of pressing the molten alloy is low, a desired paddle is less likely to be generated on the surface of the cooling roll 8. Therefore, the tapping pressure of the molten alloy from the slit 7 is preferably 5 kPa or more and less than 40 kPa. The tapping pressure is more preferably 10 kPa or more and less than 35 kPa. and still more preferably 15 kPa or more and less than 30 kPa for further stable generation of a paddle. The tapping pressure can be adjusted by the head pressure or the pressure in the molten metal storage container 5 illustrated in FIG. 1.

Hereinafter, the present invention will be described more specifically with reference to Examples. However, the present invention is not limited to the following Examples.

In an alumina crucible, 200 kg of a raw material was housed in which elements of B, C, Si, Nb, Cu, and Fe each having a purity of 99.5% or more were blended so as to obtain alloy compositions shown in Examples 1 to 6 and Comparative Examples 7 to 10 in Table 1 below, and the raw material was melted by high frequency induction heating to form a molten alloy. Into an alumina molten metal storage container having an inner diameter of 200 mm and a height of 400 mm and including a BN tapping nozzle with a slit shown in Table 1 at the bottom, 50 kg of the molten alloy was poured. Thereafter, a high frequency heating coil installed around the molten metal storage container was energized to further heat 50 kg of the molten alloy, and after the temperature of the molten alloy reached a temperature higher than the melting point of the blended composition alloy by 50° C. or more, a molten metal stopper made of alumina disposed above the tapping nozzle was pulled out. As a result, the molten alloy was ejected from the tapping nozzle to the cooling roll surface immediately below. The size and the operational parameters of the cooling roll are as shown in Table 2. The average tapping rate of the molten metal is shown in Table 3.

The molten alloy in contact with the surface of the cooling roll formed a paddle on the cooling roll surface, and the molten alloy was rapidly solidified at the interface between the paddle and the cooling roll to obtain a ribbon-shaped rapidly solidified alloy. The average thickness and the average width of the rapidly solidified alloy ribbon are as shown in Table 3.

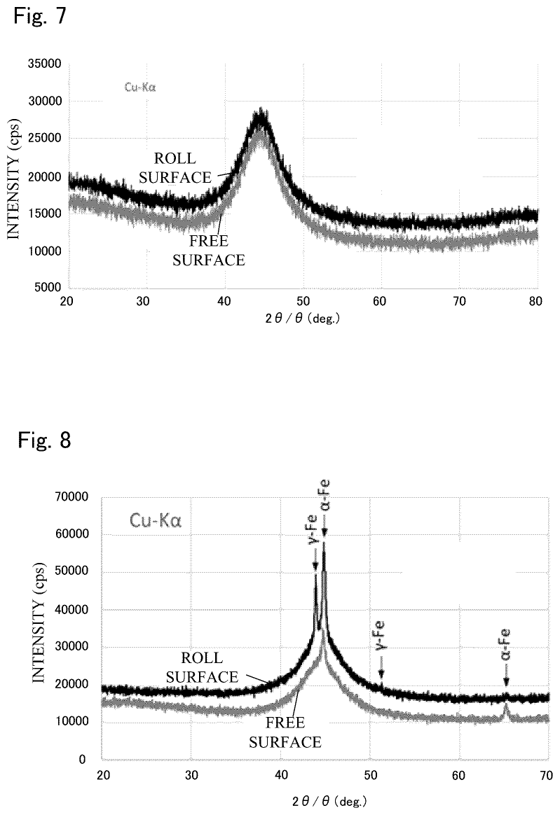

For the obtained rapidly solidified alloy ribbon, the X-ray diffraction pattern of the surface (roll surface) in contact with the cooling roll surface and the X-ray diffraction pattern of the opposite surface (free surface) not in contact with the cooling roll surface were measured, and the structure was evaluated. The results are shown in Table 3 as the volume rate of the amorphous structure. As shown in Table 3, in Examples 1 to 6, it has been confirmed that the amorphous single phase structure or the amorphous structure accounts for the most part and that the structure contains fine crystals determined to be α-Fe on the free surface side. As representative examples of the X-ray diffraction patterns on the roll surface and the free surface of the rapidly solidified alloy ribbon in Examples, the X-ray diffraction patterns in Example 1 and Example 4 are shown in FIG. 6 and FIG. 7, respectively.

Meanwhile, in Comparative Example 7, as shown in Table 3, the volume rate of the amorphous structure was lower than in Examples 1 to 6 due to the insufficient ability for rapid cooling. The X-ray diffraction patterns on the roll surface and the free surface of the rapidly solidified alloy ribbon in Comparative Example 7 are shown in FIG. 8.

On the free surface in Comparative Example 7 shown in FIG. 8, α-Fe precipitated through heterogeneous nucleation due to insufficient molten metal rapid cooling is found in the halo pattern. On the roll surface, in addition to α-Fe, γ-Fe of the austenite phase, which is observed when the molten metal rapid cooling rate is slow, is found, and it is indicated that the rapidly solidified alloy includes a part in which the molten metal rapid cooling rate is remarkably slow.

TABLE 1

| | | Alloy | Slit | Slit | Slit | Roll surface | Tapping |
|---|---|---|---|---|---|---|---|
| | | composition (atm %) | width (mm) | length (mm) | depth (mm) | speed (m/sec) | pressure (kPa) |
| Examples | 1 | Fe [symbol] B [symbol] Si [symbol] | 0.8 | 50 | 5 | 23 | 20 |
| | 2 | Fe [symbol] B [symbol] C [symbol] Si [symbol] | 0.7 | 100 | 3 | 23 | 30 |
| | 3 | Fe [symbol] B [symbol] C [symbol] Si [symbol] Nb [symbol] | 1.0 | 50 | 7 | 30 | 15 |
| | 4 | Fe [symbol] B [symbol] C [symbol] Si [symbol] | 0.9 | 150 | 5 | 25 | 15 |
| | 5 | Fe [symbol] B [symbol] Si [symbol] | 1.6 | 70 | 4 | 25 | 10 |
| | 6 | Fe [symbol] B [symbol] Si [symbol] Cu [symbol] | 0.6 | 100 | 5 | 40 | 35 |
| Comparative | 7 | Fe [symbol] B [symbol] Si [symbol] | 0.8 | 50 | 5 | 23 | 20 |
| Examples | 8 | Fe [symbol] B [symbol] C [symbol] Si [symbol] | 0.4 | 50 | 3 | 23 | 30 |
| | 9 | Fe [symbol] B [symbol] Si [symbol] | 1.6 | 50 | 4 | 25 | 10 |
| | 10 | Fe [symbol] B [symbol] Si [symbol] Cu [symbol] | 0.5 | 100 | 5 | 20 | 20 |

[symbol]

indicates data missing or illegible when filed

TABLE 2

| | | | Outer | | | | Amount of | Temperature | Nozzle/ | Roll |
|---|---|---|---|---|---|---|---|---|---|---|
| | | | diameter | Diameter | Width of | Thickness | cooling | of cooling | roll tube | surface |
| | | Material of | curvature of | of cooling | cooling | of cooling | water of | water of | Distance | Roughness |
| | | cooling roll | cooling roll | roll (mm) | roll (mm) | roll (mm) | roll (m³/min) | roll (° C.) | (mm) | Ra (nm) |
| Examples | 1 | Copper- | 2.0E−03 | 1000 | 150 | 15 | 0.8 | 30 | 0.4 | 420 |
| | 2 | chromium- | 1.3E−03 | 1500 | 300 | 20 | 1.0 | 15 | 0.5 | 380 |
| | 3 | zirconium | 8.7E−04 | 2300 | 300 | 40 | 2.0 | 55 | 0.3 | 150 |
| | 4 | | 8.7E−04 | 2300 | 350 | 40 | 10.0 | 50 | 0.4 | 750 |
| | 5 | | 1.0E−03 | 2000 | 270 | 30 | 15.0 | 5 | 7.0 | 410 |
| | 6 | Pure molybdenum | 1.3E−03 | 1500 | 300 | 30 | 15.0 | 40 | 15.0 | 1500 |
| Comparative | 7 | Copper- | 5.0E−03 | 400 | 150 | 25 | 0.3 | 15 | 0.4 | 400 |
| Examples | 8 | chromium- | 5.0E−03 | 400 | 150 | 25 | 0.3 | 15 | 0.5 | 400 |
| | 9 | zirconium | 5.0E−03 | 400 | 150 | 25 | 0.3 | 15 | 1.0 | 400 |
| | 10 | | 3.3E−03 | 600 | 300 | 30 | 0.2 | 2 | 1.0 | 250 |

TABLE 3

| | | Average | Average | Average | Volume rate |
|---|---|---|---|---|---|
| | | Thickness | Width | tapping rate | of amorphous |
| | | (μm) | (mm) | (kg/min) | (%) |
| Examples | 1 | 42 | 52 | 17.7 | 97 |
| | 2 | 39 | 101 | 31.0 | 99 |
| | 3 | 43 | 54 | 22.1 | 96 |
| | 4 | 40 | 153 | 59.7 | 95 |
| | 5 | 53 | 76 | 49.6 | 93 |
| | 6 | 34 | 102 | 26.5 | 93 |
| Comparative | 7 | 40 | 53 | 17.7 | 68 |
| Examples | 8 | 24 | 51 | 8.8 | 98 |
| | 9 | No sample was prepared because rapidly cooled | | | |
| | | alloy was wound around cooling roll. | | | |
| | 10 | 28 | 102 | 22.1 | 91 |

### INDUSTRIAL APPLICABILITY

The Fe—Si—B-based thick plate rapidly solidified alloy ribbon obtained by the present invention can be suitably used as a low-iron-loss laminated iron core that is easily applied to reactors, various motors, generators, and the like. Furthermore. instead of electrical steel sheets widely used in various transformers, motors, and the like, an Fe—Si—B-based amorphous alloy that can be used for laminated iron cores having a low iron loss and a high magnetic permeability can be provided to the market at low cost on a mass production scale.

### REFERENCE SIGNS LIST

1 single roll molten metal rapidly cooling apparatus
2 melting furnace
3 molten alloy
4 tilting shaft
5 molten metal storage container
6 tapping nozzle
7 slit
8 cooling roll
9 rapidly solidified alloy ribbon

1. A method for manufacturing an Fe—Si—B-based thick plate rapidly solidified alloy ribbon, the method comprising:
ejecting an Fe—Si—B-based molten alloy containing iron (Fe), boron (B), and silicon (Si) as essential components from a tapping nozzle to a surface of a cooling roll and rotating the cooling roll at a surface speed of 15 m/sec or more and 50 m/sec or less to rapidly cool the Fe—Si—B-based molten alloy on the surface of the cooling roll to manufacture an alloy ribbon,
the tapping nozzle including a single slit formed to have a width of 0.6 mm or more and less than 2.0 mm,
the cooling roll having a curvature of 8×10⁻⁴ or more and less than 2×10⁻³; and
passing cooling water in an amount of 0.3 m³/min or more and less than 20 m³/min at 5° C. or more and less than 60° C. through the cooling roll to manufacture a rapidly solidified alloy ribbon having an average thickness of 30 μm or more and less than 55 μm.

2. The method for manufacturing an Fe—Si—B-based thick plate rapidly solidified alloy ribbon according to claim 1, wherein the single slit of the tapping nozzle has a length of 20 mm or more and less than 300 mm.

3. The method for manufacturing an Fe—Si—B-based thick plate rapidly solidified alloy ribbon according to claim 1, wherein the cooling roll includes a material containing one of Cu, Mo, or W as a main component, has an arithmetic average roughness Ra of the surface of 10 nm or more and less than 20 μm, is formed to have a length longer than the length of the single slit by 50 mm or more and less than 400 mm, and has a thickness from the surface to a flow channel of the cooling water of 5 mm or more and less than 50 mm.

4. The method for manufacturing an Fe—Si—B-based thick plate rapidly solidified alloy ribbon according to claim 1, wherein the Fe—Si—B-based molten alloy is ejected from the single slit at a tapping pressure of 5 kPa or more and less than 40 kPa.

5. The method for manufacturing an Fe—Si—B-based thick plate rapidly solidified alloy ribbon according to claim 1, wherein the cooling roll has a diameter of 1000 mm or more and less than 2500 mm.

6. The method for manufacturing an Fe—Si—B-based thick plate rapidly solidified alloy ribbon according to claim 1, wherein the Fe—Si—B-based molten alloy has a composition formula represented by T_{100-x-y-z-n}QₓSi_{y}Mₙ wherein T represents a transition metal element including at least one element selected from the group consisting of Fe, Co, and Ni, the transition metal element necessarily including Fe, Q represents one or more elements selected from the group consisting of B and C, the one or more elements necessarily including B, M represents one or more elements selected from the group consisting of P, Al, Ti, V, Cr, Mn, Nb, Cu, Zn, Ga, Mo, Ag, Hf, Zr, Ta, W, Pt, Au, and Pb, and composition ratios x, y, and n satisfy 5≤×<20 atom %, 2≤y<15 atom %, and 0≤n<10 atom %.

7. A laminated iron core produced by processing an Fe—Si—B-based thick plate rapidly solidified alloy ribbon manufactured by the method for manufacturing an Fe—Si—B-based thick plate rapidly solidified alloy ribbon according to claim 1 into a desired shape.
